(19) United States
(12) Patent Application Publication
(10) Pub. No.: US 2010/0026225 A1
(43) Pub. Date: Feb. 4, 2010

(54) Electric Device

(75) Inventors: Hiroki Kamei, Osaka (JP); Hiroshi Takao, Osaka (JP)

Correspondence Address: NDQ&M WATCHSTONE LLP, 1300 EYE STREET, NW, SUITE 1000 WEST TOWER, WASHINGTON, DC, 20005, US

(73) Assignee: Sanyo Electric Co, Ltd., Osaka (JP)

(21) Appl. No.: 12/593,509

(22) PCT Filed: Mar. 27, 2008
(86) PCT No.: PCT/JP2008/055881

§ 371 Date: Sep. 28, 2009

(30) Foreign Application Priority Data
Mar. 29, 2007 (JP) 2007086903
Mar. 21, 2008 (JP) 2008073234

(51) Int. Cl. H02H 3/04; H02H 7/08

(52) U.S. Cl. 318/471; 318/490

(57) ABSTRACT

Provided is an electric device capable of encouraging a user to perform maintenance in a forceful manner when the performance such as safety, operation efficiency or the like decreases.

In an electric device of the present invention, a control circuit controlling an operation of the actuator includes detecting means for detecting a drive condition value which varies in accordance with deterioration of one or a plurality of components forming the electric device, and output limit means for limiting an output of the actuator in accordance with the drive condition value detected by the detecting means.

### FIELD OF THE INVENTION

The present invention relates to an electric device operating by using various actuators as drive source such as an electric vehicle and home electric appliance.

### DESCRIPTION OF RELATED ART

Conventionally, it has been suggested a technique of, in a hybrid electric vehicle, not allowing the operation of an electricity generator when an integration travel distance after a fully charged condition reaches a predetermined value to inhibit the use of the electricity generator (use of fuel such as gasoline or the like), thereby trying to clean global environment (for example, see Japanese Patent Publication No. 3018958).

Also, it has been suggested a technique of, in a fuel cell system, being interconnected with a commercial power system, calculating life duration from the number of output fluctuations, and, when the end of the life duration is close, decreasing the output to elongate the life duration (for example, see Japanese Laid-Open Patent Publication No. 2007-042436).

### DISCLOSURE OF THE INVENTION

### Problems to be Solved by the Invention

An electronic component is an important element in structure of the electric device. However, it is very difficult to determine the change or deterioration by lapse of years of all components due to structure or cost. From the safety point of view, it is necessary to avoid a situation where the actuator such as a motor or the like stops or runs out of control during the operation of the electric device due to the breakage failure or deterioration of the electronic components.

In order to avoid such a situation, it is necessary to inform a user that the usage durable time of the electric device is over and encourage the user to perform maintenance, before the electronic components deteriorate to decrease the performance such as safety, operation efficiency or the like.

However, a conventional electric device which encourages the user to perform maintenance before the electronic components deteriorate to decrease the performance such as safety, operation efficiency or the like is not known. Even if an alert is issued to the user when the total usage time reaches a predetermined value, the user could ignore the alert. Therefore, it has been problematic because the maintenance is not performed at an appropriate time resulting in a decrease in the performance such as safety, operation efficiency or the like.

An object of the present invention is to provide an electric device capable of encouraging the user to perform maintenance in a forceful manner when the performance such as safety, operation efficiency or the like decreases along with an increase in the operation time.

### Means for Solving the Problem

An electric device of the present invention comprises a drive part driven by an actuator and a control circuit controlling an operation of the actuator, and the control circuit includes detecting means for detecting a drive condition value which varies in accordance with deterioration of one or a plurality of components forming the electric device, and output limit means for limiting an output of the actuator in accordance with the drive condition value detected by the detecting means.

In particular, the output limit means of the control circuit reduces a limit value of the actuator output after the drive condition value reaches a predetermined duration value from a maximum limit value to a minimum limit value.

Also in particular, the drive condition value is drive time, an integration value of environmental temperature or component temperature, an integration value of current fluctuation or voltage fluctuation flowing in the actuator, an integration value of torque fluctuation, an integration value of driving speed fluctuation or a value varying in accordance with these values.

In particular, in the case where the electric device is an electric vehicle, the drive condition value is an integration value of travel distance, travel time or velocity variation, an integration value of motor torque fluctuation, or a value varying in accordance with these values.

The actuator output defines the current or voltage flowing in the actuator, the torque, operation velocity of the actuator, or an operation mode which can be transited.

In particular, in the case where the electric device is an electric vehicle, the actuator output is the motor torque, a motor rotation number, a motor current, a current supplied from a battery to the motor, a voltage supplied from the battery to the motor, or an electric power supplied from the battery to the motor.

According to the electric device of the present invention described above, when the drive condition value (for example, the integration value of travel distance) reaches the predetermined duration value, the limit value of the actuator output (for example, the motor torque) decreases from the maximum limit value during normal operation to the minimum limit value during deterioration of the durability, and therefore, the actuator output in accordance with a user order cannot be obtained. As a result, the user must perform the maintenance such as repair or replacement of a component in order to obtain normal performance.

According to the structure in which the limit value of the actuator output gradually decreases from the maximum limit value to the minimum limit value in accordance with the variation of the drive condition value, when the drive condition value (for example, the integration value of the travel distance) reaches the predetermined duration value, the actuator output (for example, the motor output) does not decrease drastically. Therefore, it is safe.

In a particular configuration, the actuator output limits temperature of a specified component forming the electric device to not exceeding a predetermined limit value. The limit value of the component temperature decreases from the maximum limit value to the minimum limit value after the drive condition value reaches the duration value.

According to this particular configuration, the temperature of the specified component forming the electric device is inhibited by the limitation of the actuator output, and does not exceed the predetermined limit value. Thereby the life duration of this component is elongated.

In another particular configuration, comprised is reset means for resetting the limit value of the actuator output to the maximum limit value during normal operation in accordance with the performing of the maintenance.

Since the limit value of the actuator output is thereby restored to the maximum limit value during normal operation after performing the maintenance, it is possible to continue to run in a normal travelling performance.

More specifically, the duration value of the drive condition value is set for each of a plurality of components forming the electric device, and the duration value of a specified component of them is updated every time the maintenance of the component is performed.

According to this particular configuration, the user is encouraged to perform maintenance of every component, and therefore, the maintenance can be performed at an appropriate time.

In a further particular configuration, after the drive condition value reaches the predetermined duration value, every time the actuator stops or every time a power source of the electric device is turned on, the control circuit reflects the limit value of the actuator output at that time in limitation of the actual actuator output.

According to this particular configuration, the limit value of the actuator output does not change during the operation after the drive condition value reaches the predetermined duration value to decrease the actuator output. Therefore, it is safe.

The limitation of the actuator output by the control circuit can be performed on a maximum value of the actuator output in a response of the actuator output in accordance with the user order, a change ratio of the actuator output or responsiveness of the actuator output.

### EFFECT OF THE INVENTION

According to the electric device of the present invention, it is possible to encourage the user to perform maintenance in a forceful manner when the performance such as safety, operation efficiency or the like deteriorates along with the usage.

### BRIEF DESCRIPTION OF THE DRAWINGS

FIG. 1 is a block diagram showing a first basic structure of an electric device of the present invention;

FIG. 2 is a block diagram showing a second basic structure of the electric device of the present invention;

FIG. 3 is a block diagram showing a structure of an electric vehicle in which the present invention is implemented;

FIG. 4 is a view showing a limitation state of an output torque in accordance with a travel distance;

FIG. 5 is a flow chart showing a control procedure in a case where limitation of the output torque in accordance with the travel distance is performed;

FIG. 6 is a view showing a limitation state of component temperature in accordance with the travel distance;

FIG. 7 is a flow chart showing a control procedure in a case where limitation of the component temperature in accordance with the travel distance is performed;

FIG. 8 is a chart explaining one embodiment in which an operation history is a drive condition value;

FIG. 9 is a chart explaining another embodiment in which the operation history is the drive condition value;

FIG. 10 is a view showing a structure of a circuit for measuring a deteriorating condition of an electrolytic capacitor;

FIG. 11 is a flow chart showing a procedure for measuring the deteriorating condition of the electrolytic capacitor;

FIG. 12 is a block diagram showing an electric device formed by a plurality of systems;

FIG. 13 is a block diagram showing a structure of a control circuit in an embodiment in which an output limitation is performed by an SOH of a battery;

FIG. 14 is a flow chart showing a selection procedure of an output limit representative value in the electric device formed by the plurality of systems;

FIG. 15 is a view showing an example in which the torque limitation is reflected when a motor stops and when a power supply is turned on again;

FIG. 16 is a view showing an example in which the torque limitation is reflected only when the power source is turned on again;

FIG. 17 is a flow chart showing a control procedure in the case where the torque limitation is reflected when the motor stops and when the power source is turned on again;

FIG. 18 is a flow chart showing a control procedure in the case where the torque limitation is reflected only when the power source is turned on;

FIG. 19 is a view showing an example in which a durable travel distance is reset by performing the maintenance;

FIG. 20 is a view showing two examples in which a limit value of a motor torque varies;

FIG. 21 is a view explaining a method of updating the durable travel distance of a plurality of components;

FIG. 22 is a view showing an exemplary response of the motor torque in accordance with a throttle opening;

FIG. 23 is a block diagram showing an example in which the output limitation is performed by limiting an operation mode which can be selected by a user;

FIG. 24 is a flow chart showing an example of a procedure of selecting the operation mode;

FIG. 25 is a chart showing a relation between each operation mode and limit durable time;

FIG. 26 is a flow chart showing another example of the procedure of selecting the operation mode;

FIG. 27 is a chart showing another relation between each operation mode and limit durable time;

FIG. 28 are graphs showing two methods of reducing a load to be applied to the system; and

FIG. 29 is a flow chart showing a procedure of the output limitation by the operation mode and a maximum output torque.

### EXPLANATION OF LETTERS OR NUMERALS

1. Travel distance measuring part
2. Throttle sensor input part
3. Durable travel distance holding part
4. Output torque limit value generation part
5. Output torque generation part
6. Motor output control part
7. Motor
8. Control circuit
9. Battery

### BEST MODE FOR CARRYING OUT THE INVENTION

An embodiment of the present invention is to be described in detail below with reference to the drawings.

[First Basic Structure]

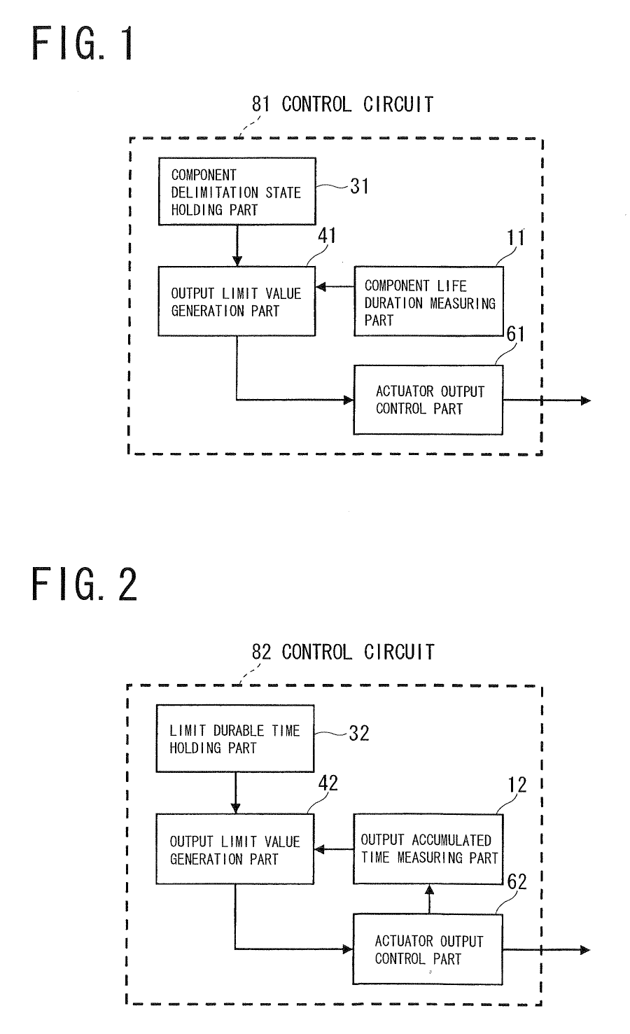

FIG. 1 shows a basic structure of a control circuit 81 of the present invention implemented in an electric device represented by a home electric appliance such as an air conditioner or the like. The control circuit 81 controls an output of an actuator such as a motor or the like.

The control circuit 81 comprises a component life duration measuring part 11 measuring a component life duration value (for example, an integration value of component temperature or the number of turning ON/OFF times) reflected in a life duration of a component forming the electric device, a component delimitation state holding part 31 holding component delimitation state (for example, a duration value for the number of turning ON/OFF times) where the durability decreases due to deterioration of a specified component, an output limit value generation part 41 generating the limit value of actuator output in accordance with the component life duration value and the component delimitation state, and an actuator output control part 61 controlling the actuator output in accordance with the output limit value.

[Second Basic Structure]

FIG. 2 shows a basic structure of a control circuit 82 of the present invention implemented in various electric devices represented by an electric vehicle such as a hybrid car or the like. The control circuit 82 controls an output of an actuator such as a motor or the like.

The control circuit 82 comprises an output accumulated time measuring part 12 measuring an accumulated value of time for which the actuator has operated, a limit durable time holding part 32 holding a limit durable time where the durability decreases due to deterioration of a specified component, an output limit value generation part 42 generating the limit value of the actuator output in accordance with the accumulated value of the time and the limit durable time, and an actuator output control part 62 controlling the actuator output in accordance with the output limit value.

### Various Embodiments

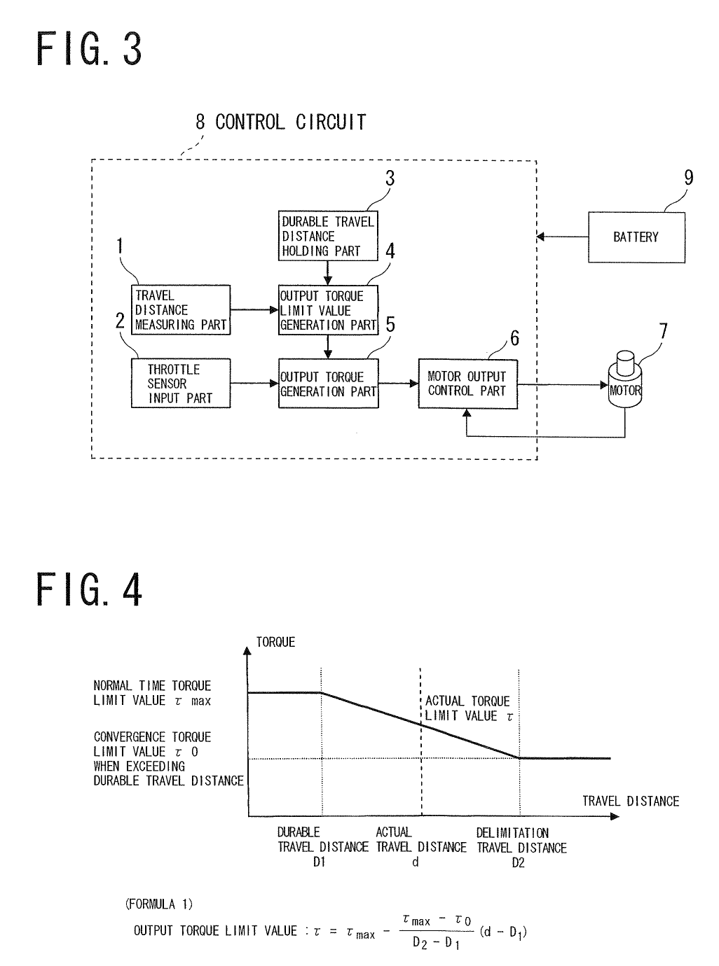

FIG. 3 shows a structure of an electric vehicle in which the present invention is implemented. The electric vehicle runs by means of a rotation of a motor 7, using a battery 9 as a power source. The motor 7 is controlled by a control circuit 8.

The control circuit 8 comprises a travel distance measuring part 1 measuring an integrated travel distance of the vehicle, a throttle sensor input part 2 detecting an throttle opening, a durable travel distance holding part 3 holding a travel distance (durable travel distance) where durability decreases due to deterioration of a specified component, an output torque limit value generation part 4 generating a limit value of an output torque in accordance with the travel distance and the durable travel distance, an output torque generation part 5 generating the output torque in accordance with the throttle opening and the output torque limit value, and a motor output control part 6 controlling a motor output in accordance with the generated output torque.

FIG. 4 shows variation of the output torque limit value in accordance with the travel distance. The output torque limit value is maintained at a constant normal time torque limit value τmax until the travel distance reaches a durable travel distance D1. Thereafter, while the travel distance is increasing to a delimitation travel distance D2, the output torque limit value gradually reduces from the normal time torque limit value τmax to a convergence torque limit value τ0. After the travel distance exceeds the delimitation travel distance D2, it is maintained at the convergence torque limit value τ0.

A torque limit value τ when an actual travel distance d is the durable travel distance D1 or greater and delimitation travel distance D2 or smaller can be calculated by using a formula 1 in the figure.

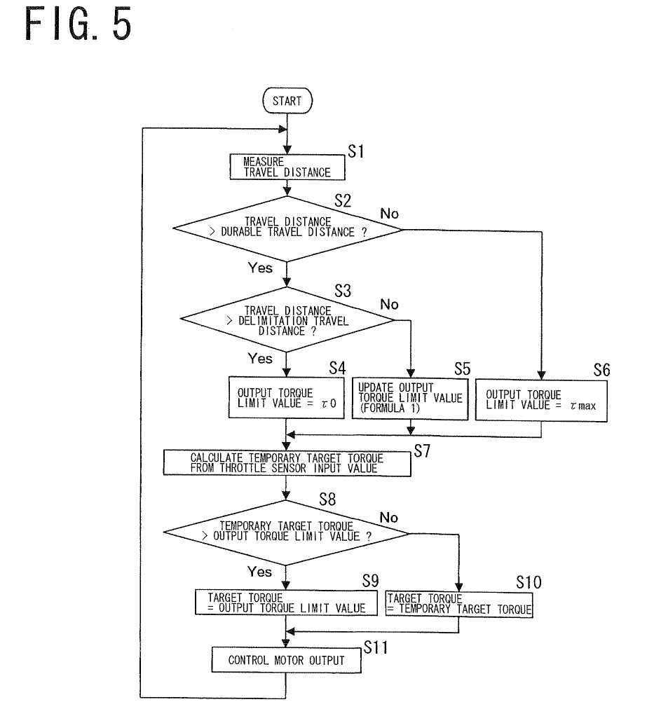

FIG. 5 shows a procedure of a motor output control performed by the control circuit 8. First in step S1, the travel distance since a previously performed maintenance is measured. And then in step S2, it is determined whether or not the travel distance is greater than the durable travel distance. When it is determined NO, the process proceeds to step S6 to set the output torque limit value to the normal time torque limit value τmax.

When it is determined YES in step S2, it is determined whether or not the travel distance is greater than the delimitation travel distance in step S3. When it is determined NO, the process proceeds to step S5 to update the output torque limit value to a value calculated by using the formula 1. When it is determined YES in step S3, the process proceeds to step S4 to set the output torque limit value to the convergence torque limit value τ0.

Thereafter in step S7, a temporary target torque is calculated from a throttle sensor input value, and then, in step S8, it is determined whether or not the temporary target torque is greater than the output torque limit value. When it is determined YES, the output torque limit value is set as a target torque in step S9. When it is determined NO, the temporary target torque is set as the target torque in step S10. Thereafter in step S11, the motor output control is performed based on the target torque, and then, the process returns to step S1.

According to the control procedure described above, as shown in FIG. 4, the normal time torque limit value τmax is set until the travel distance reaches the durable travel distance D1, and therefore, a normal output torque in accordance with the throttle opening is obtained to give a normal travelling performance.

Thereafter, after the travel distance exceeds the durable travel distance D1, set is the torque limit value which gradually decreases in accordance with the travel distance until the travel distance reaches the delimitation travel distance D2. Therefore, the output torque is gradually limited. After the travel distance exceeds the delimitation travel distance D2, set is the constant convergence torque limit value τ0. As a result, the output torque in accordance with the throttle opening is not obtained and the travelling performance decreases, and therefore, the user can recognize the situation.

Thus, the user must perform maintenance such as repair or replacement of a component in order to obtain normal travelling performance.

Even when the travel distance exceeds the durable travel distance D1 as described above, since the torque limit value gradually decreases from the normal time torque limit value τmax to the convergence torque limit value τ0, the output torque of the motor does not decreases drastically. Therefore, it is safe.

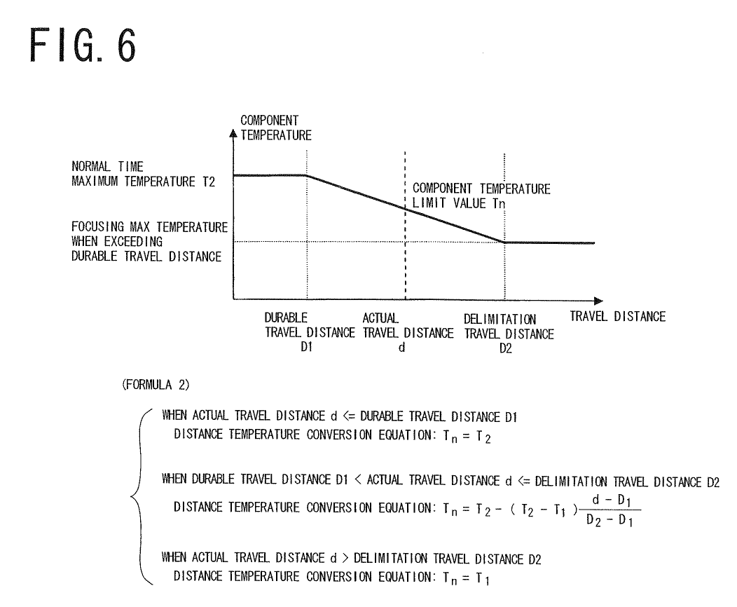

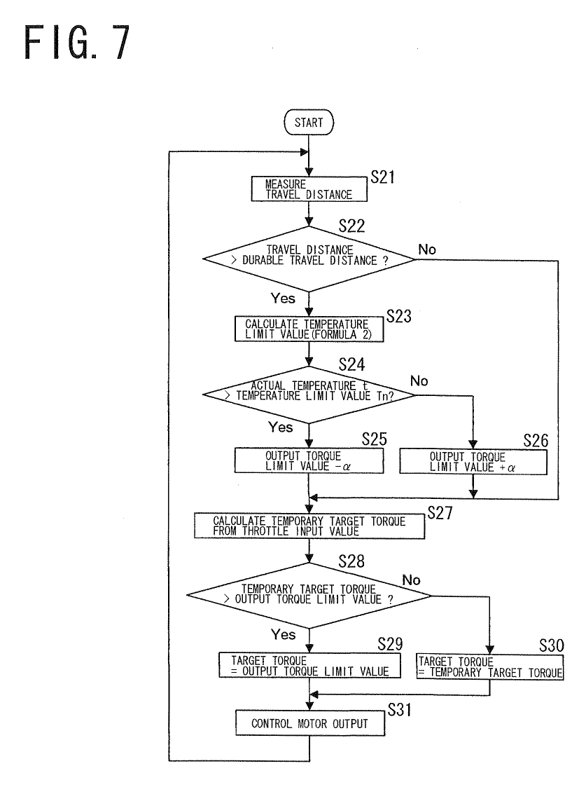

FIGS. 6 and 7 show a configuration in which the motor output is limited so that temperature of a specified component forming the electric vehicle does not exceed a predetermined limit value. The limit value of the component temperature maintains at a constant normal time maximum temperature T2 until the travel distance reaches the durable travel distance D1 as shown in FIG. 6. Thereafter, while the travel distance is reaching the delimitation travel distance D2, the limit value of the component temperature gradually decreases from the normal time maximum temperature T2 to a convergence maximum temperature T1. After the travel distance exceeds the delimitation travel distance D2, it is maintained at the convergence maximum temperature T1.

A component temperature limit value Tn when the actual travel distance d is the durable travel distance D1 or greater and the delimitation travel distance D2 or smaller can be calculated by using a formula 2 in the figure.

FIG. 7 shows the procedure of the motor output control performed by the control circuit 8. First in step S21, the travel distance since a previously performed maintenance is measured. And then in step S22, it is determined whether or not the travel distance is greater than the durable travel distance. When it is determined NO, the process proceeds to step S27.

When it is determined YES in step S22, the temperature limit value is calculated by using the formula 2 in step S23. Next in step S24, it is determined whether or not the actual component temperature t exceeds the temperature limit value Tn. When it is determined YES, the process proceeds to step S25 to decrease the output torque limit value by a predetermined value α. When it is determined NO in step S24, the process proceeds to step S26 to increase the output torque limit value by the predetermined value α.

Thereafter in step S27, a temporary target torque is calculated from the throttle sensor input value, and then, in step S28, it is determined whether or not the temporary target torque is greater than the output torque limit value. When it is determined YES, the output torque limit value is set as a target torque in step S29. When it is determined NO, the temporary target torque is set as the target torque in step S30. Thereafter in step S31, the motor output control is performed based on the target torque, and then, the process returns to step S21.

According to the control procedure described above, as shown in FIG. 6, the normal time maximum temperature T2 is set as the limit value of the component temperature until the travel distance reaches the durable travel distance D1, and therefore, a normal output torque in accordance with the throttle opening is obtained to give a normal travelling performance.

Thereafter, after the travel distance exceeds the durable travel distance D1, the component temperature limit value Tn which gradually decreases in accordance with the travel distance is set until the travel distance reaches the delimitation travel distance D2. Therefore, the output torque is gradually limited. After the travel distance exceeds the delimitation travel distance D2, set is the constant convergence maximum temperature T1. As a result, the output torque in accordance with the throttle opening is not obtained and the travelling performance decreases, and therefore, the user can recognize the situation.

Thus, the user must perform maintenance such as repair or replacement of a component in order to obtain a normal travelling performance.

In the case where the component temperature is limited, the component temperature limit value can be determined based on a relation between the temperature and life duration of the component, for example, Arrhenius equation in the electrolytic capacitor. In a motor, since deterioration of lubricant oil used in a bearing is affected by the temperature, the temperature limit value can be determined from this point of view.

In a component formed by a semiconductor, migration progresses along with the temperature increase, to possibly cause a disconnection, and therefore, the temperature limit value can be determined from this point of view. Also in a switch, since malfunction occurs due to the temperature decrease and the life duration is considerably shortened in a high temperature environment due to deterioration of an insulator, the temperature limit value can be determined from this point of view.

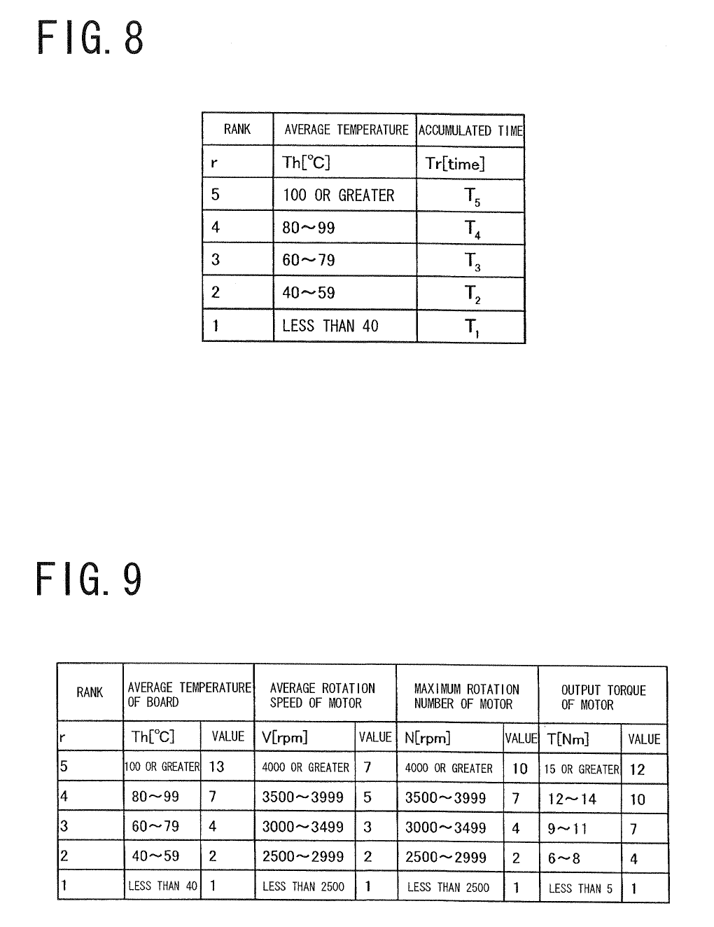

FIG. 8 shows one embodiment in which an operation history is a drive condition value. One of elements which influence the life duration of a circuit board is a board temperature. An average board temperature is measured for each unit time (for example, one minute), and then, the usage time is integrated for each temperature range ranked according to degree of the influence.

As shown in a formula 3 below, calculated is an integration value (a life duration accumulated value L) of the integrated time for each temperature range (rank r) multiplied by a weighting coefficient wᵢ, and the calculated life duration accumulated value L is used as the drive condition value to limit the actuator output after the life duration accumulated value L reaches a predetermined duration value.

L=Σ(WᵢTᵢ) i=1, 2, 3, 4, 5 Formula 3

For the drive condition value, instead of the average board temperature, it is also possible to adopt an average rotation speed of the motor, total rotation speed, torque, current, voltage, electric power or the like.

As another example in which the operation history is the drive condition value, it is possible to adopt a method in which when an accumulated value of a circuit load for each unit time (minute) exceeds a predetermined delimitation value, the actuator output is limited. The element which influences the life duration of the circuit board includes the motor rotation number or output torque along with the board temperature.

As shown in FIG. 9, values which these elements could take are ranked according to magnitude of the load. And then, the value of each element is set for each rank, and the values of the elements are multiplied by each other to be used as a magnitude Li of the circuit load for a unit time. An integration value L of the magnitude Li of the circuit load (formula 4) is used as the drive condition value to limit the actuator output after the integration value L reaches a predetermined duration value.

In an example shown in FIG. 9, the value of “average temperature of the board” in the rank 5 is set to 13, and the value of “average rotation speed of the motor” in the rank 5 is set to 7.

L=ΣLᵢ i=1, 2, 3, . . . usage time (n minute) Formula 4

The magnitude Li of the circuit load is not limited to the multiplied value of the values of the elements, but it is also possible to adopt a summed value of the values of the elements.

It is also possible to further add the current, voltage, electric power and the like to the above mentioned elements for the drive condition value.

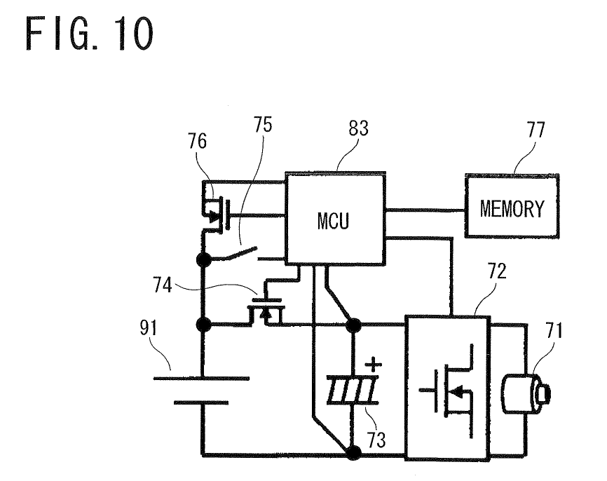

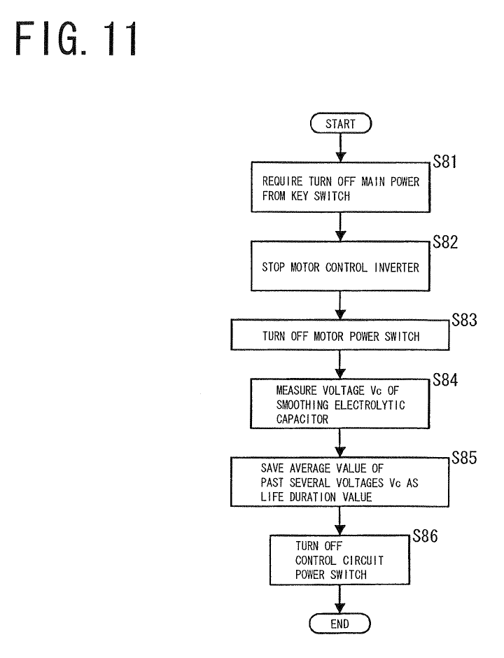

FIGS. 10 and 11 show an embodiment of a method of measuring deterioration condition (life duration value) of the electrolytic capacitor which is a component forming the electric device. As the method of measuring the deterioration condition of the electrolytic capacitor, known are a method of measuring voltage fluctuation (ripple), a method of measuring equivalent series resistance (ESR) of the electrolytic capacitor, and a method of measuring capacitance of the electrolytic capacitor. In this embodiment, the capacitance of the electrolytic capacitor is measured.

In FIG. 10, the electric power of a power source 91 is supplied via a smoothing electrolytic capacitor 73 to a motor control inverter 72 with the ripple eliminated. The motor control inverter 72 drives a motor 71. A nonvolatile memory 77 is connected to a motor control circuit 83.

The motor control circuit 83 controls the motor control inverter 72, detects turning ON/OFF of a key switch 75 operated by the user, and controls a motor power switch 74 and a control circuit power switch 76. Further, the motor control circuit 83 is capable of measuring a voltage across the smoothing electrolytic capacitor 73.

FIG. 11 shows a procedure of measuring the deterioration condition of the electrolytic capacitor. The capacitance of the electrolytic capacitor can be confirmed by measuring the voltage across the electrolytic capacitor when the electric power supply is shut after the electrolytic capacitor is charged by the electric power supply.

First in step S81, the key switch turns off and a requirement of turning off a main power source is issued. In response to this, in step S82, the motor control inverter stops, and then in step S83, the motor power switch turns off. Thereby the electrolytic capacitor is in a state where electric charge is accumulated and the electric power is not supplied.

In this state, in step S84, a voltage Vc across the smoothing electrolytic capacitor is measured, and then in step S85, an average value of past several voltages Vc is calculated and saved in the nonvolatile memory as the life duration value.

At last in step S86, the control circuit power switch turns off and a power source of the system turns off.

Although the embodiment is explained above by using the electrolytic capacitor, it is possible to measure deterioration condition of another component as long as it is a component capable of confirming the deterioration condition, and to perform the limitation of the output based on the measurement result. For example, in the case where the deterioration condition of EEPROM is measured, when the number of times of writing into the EEPROM exceeds a predetermined duration value (for example, one million times), the output is limited. In the case of a potentiometer (variable resistor), when the number of slide times of a sliding part exceeds a predetermined duration value, the output limitation is performed. Further, in the case of a relay or switch, the output limitation can be performed by using the accumulated number of turning ON/OFF times.

The component which measures the deterioration condition is not limited to an essential component of the device, but may be a component for monitoring capable of monitoring the deterioration condition.

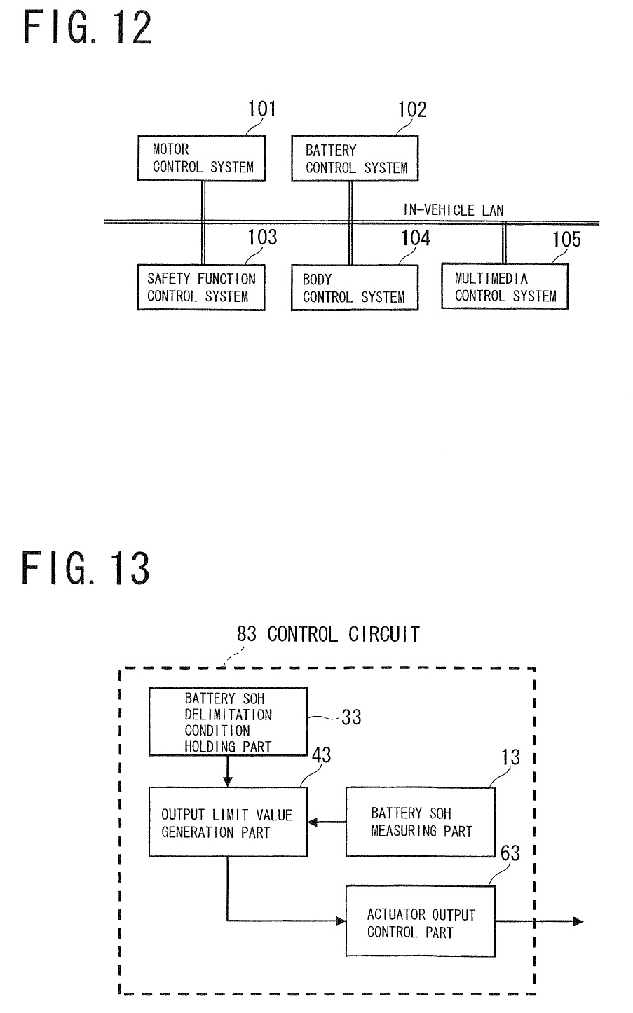

FIG. 12 shows a structure of an electric vehicle in which a plurality of systems such as a motor control system 101, a battery control system 102, a safety function control system 103, a body control system 104, a multimedia control system 105 and the like are connected to each other by an in-vehicle LAN. Each of the plurality of systems is independent and communicates and cooperates with other systems via the in-vehicle LAN.

In the case where a system other than the motor control system 101 cannot perform the notice of the maintenance timing to the user by the output limitation, for example, in the case where the battery control system 102 is reaching the end of the life duration, the battery control system 102 sends a notice data regarding the life duration to the motor control system 101, whereby the motor control system 101 performs the output limitation instead of the battery control system 102 to encourage the user to perform the maintenance.

FIG. 13 shows a structure of the control circuit 83 in the case where the notice data regarding the life duration from another system is an SOH (State Of Health) indicating the life duration of the battery. In the control circuit 83, an output limit value generation part 43 compares the SOH measured by a battery SOH measuring part 13 and an SOH delimitation value (duration value) held in an SOH delimitation condition holding part 33, and, when the measured value of the SOH exceeds the SOH delimitation value, generates the output limit value to supply it to an actuator output control part 63. Thereby the output of the actuator is limited.

When the value of the SOH is between the SOH limit value and the SOH delimitation value, the output is gradually decreased along with the increase in the SOH, and, after the value of the SOH reaches the SOH delimitation value, the output is set to a minimum value.

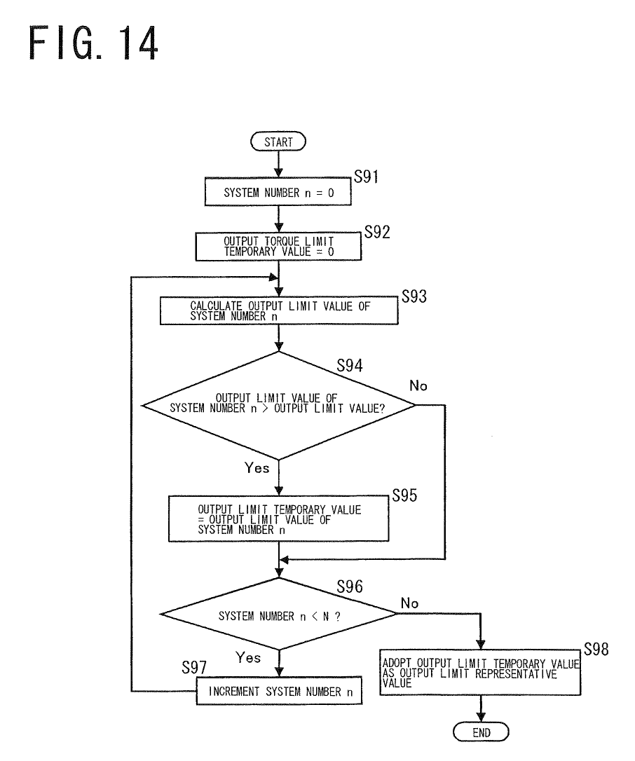

FIG. 14 shows a control procedure in the case where two or more systems are limited at the same time in the electric device which comprises N components. First in step S91, a system number is reset to zero, and an output torque limit temporary value is reset to zero.

Next in step S93, the output limit value of the system number n, and then, in step S94, it is determined whether or not the output limit value of the system number n is greater than the output torque limit temporary value. When it is determined YES, the output limit value of the system number n is set as the output limit temporary value in step S95, and then, the process proceeds to step S96. When it is determined NO in step S94, the process proceeds to step S96.

In step S96, it is determined whether or not the system number n is smaller than N. When it is determined YES, the system number n is incremented in step S97. Thereafter, the process returns to step S93 to repeat the calculation of the output limit value of the system number n. Thereafter, when it is determined NO in step S96, the process proceeds to step S98, and the output limit value is adopted as an output limit representative value. And then, the process ends.

As a result, a maximum output limit value is selected as the output limit representative value.

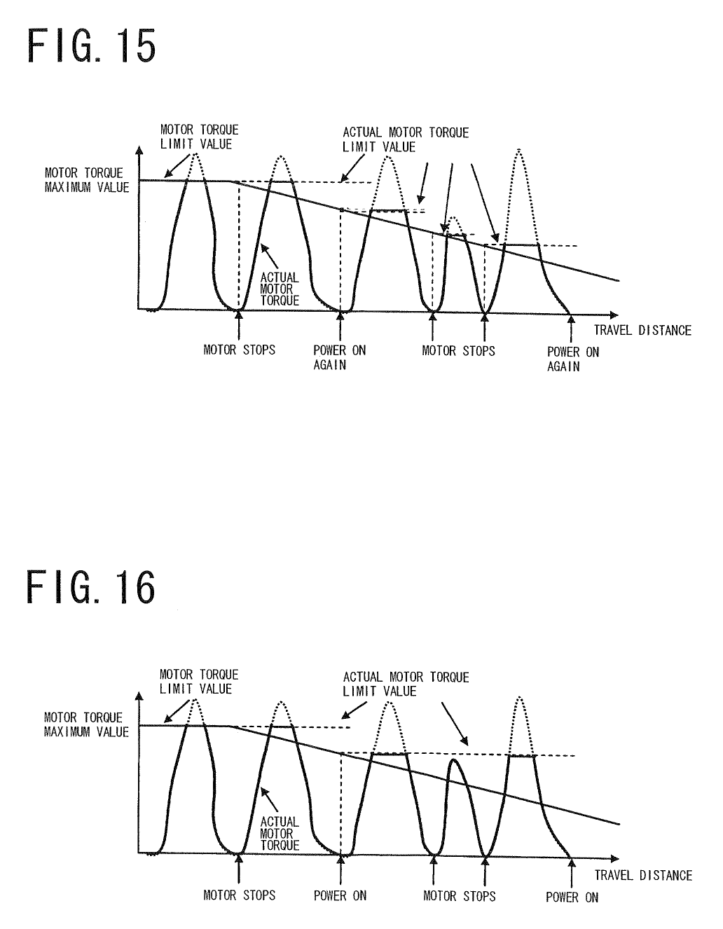

FIGS. 15 and 16 show examples in which the timing of reflecting a preliminarily-set limit value of the motor output in the limitation of the actual motor output is when the motor stops or when the power source turns on (when the power source turns on again) by turning on an ignition.

In the example shown in FIG. 15, when the motor stops and when the power source turns on again, the limit value of the motor output is reflected in the limitation of the actual motor output, and the motor torque limit value at the time the motor stops or the power source turns on again is used in the limitation of the torque in the travelling thereafter.

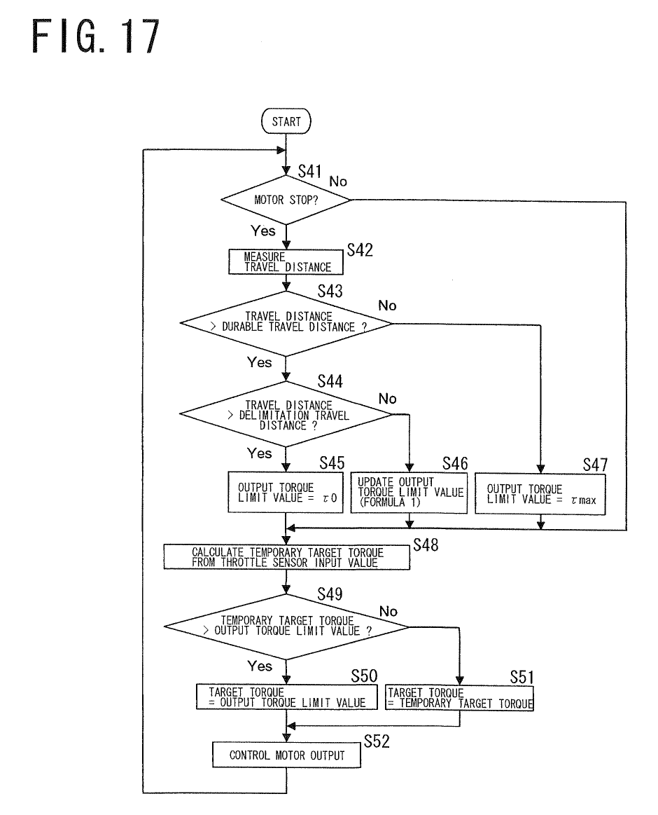

FIG. 17 shows a procedure of the motor output control performed by the control circuit 8 in this case. First in step S41, it is determined whether or not the motor stops. When it is determined YES, the travel distance is measured in step S42. In step S43, it is determined whether or not the travel distance is greater than the durable travel distance. When it is determined NO, the process returns to step S47 to set the output torque limit value to the normal time torque limit value τmax.

When it is determined NO in step S41, the process proceeds to step S48.

When it is determined YES in step S43, it is determined whether or not the travel distance is greater than the delimitation travel distance in step S44. When it is determined NO, the process proceeds to step S46 to update the output torque limit value to a value calculated by using the formula 1. When it is determined YES in step S44, the process proceeds to step S45 to set the output torque limit value to the convergence torque limit value τ0.

Thereafter in step S48, a temporary target torque is calculated from the throttle sensor input value, and then, in step S49, it is determined whether or not the temporary target torque is greater than the output torque limit value. When it is determined YES, the output torque limit value is set as a target torque in step S50. When it is determined NO, the temporary target torque is set as the target torque in step S51. Thereafter in step S52, the motor output control is performed based on the target torque, and then, the process returns to step S41.

Also, in the example shown in FIG. 16, the limit value of the motor output is reflected in the limitation of the actual motor output only when the power source turns on again. When the motor stops, the variation of the motor torque limit value is ignored. On the other hand, the motor torque limit value when the power source turns on again is used in the limitation of the torque in the travelling thereafter.

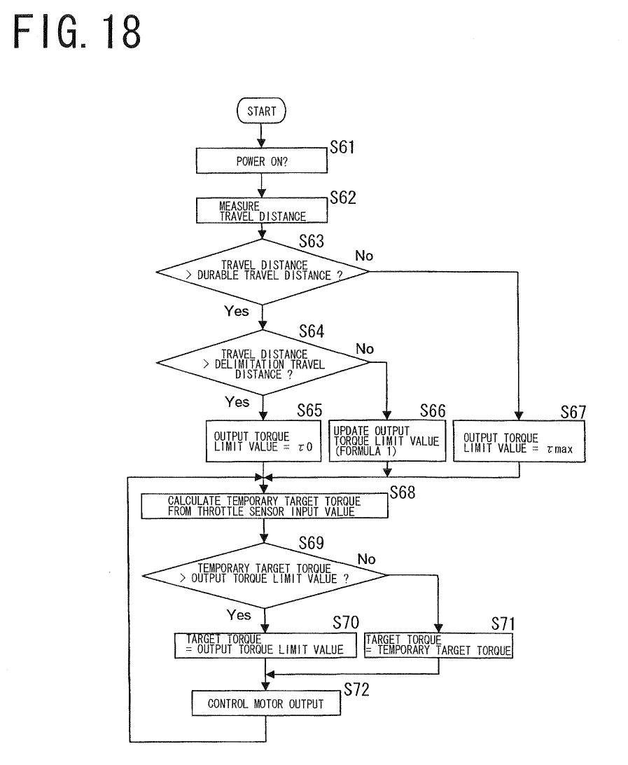

FIG. 18 shows a control procedure in the case where the limitation of the output torque is performed only once soon after the power source turns on again. First in step S61, the power source turns on. And then in step S62, the travel distance is measured. In step S63, it is determined whether or not the travel distance is greater than the durable travel distance. When it is determined NO, the process proceeds to step S67 to set the output torque limit value to the normal time torque limit value τmax.

When it is determined YES in step S63, it is determined whether or not the travel distance is greater than the delimitation travel distance in step S64. When it is determined NO, the process proceeds to step S66 to update the output torque limit value to a value calculated by using the formula 1. When it is determined YES in step S64, the process proceeds to step S65 to set the output torque limit value to the convergence torque limit value τ0.

Thereafter in step S68, a temporary target torque is calculated from the throttle sensor input value, and then, in step S69, it is determined whether or not the temporary target torque is greater than the output torque limit value. When it is determined YES, the output torque limit value is set as a target torque in step S70. When it is determined NO, the temporary target torque is set as the target torque in step S71. Thereafter in step S72, the motor output control is performed based on the target torque, and then, the process returns to step S68.

As described above, according to the structure in which the timing of reflecting the limit value of the motor output in the limitation of the actual motor output is when the motor stops, when the power source turns on (when the power source turns on again), or both of the timings, the motor output limit value does not vary during the travelling to decrease the motor output, and therefore, it is safe.

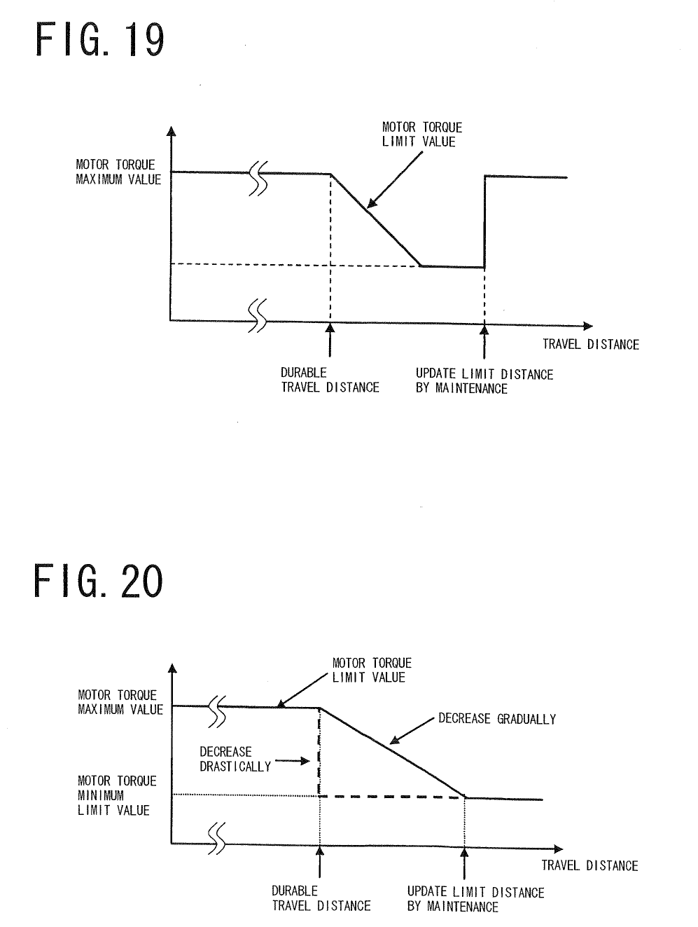

FIG. 19 shows a configuration in which when the maintenance such as repair or replacement of a component the durability of which deteriorated because the travel distance had exceeded the durable travel distance, the limit value of the motor output is reset to a normally travel time motor maximum value.

According to this configuration, by performing the maintenance, the normal travelling performance is obtained until the travel distance reaches the durable travel distance next time.

FIG. 20 shows by using dotted lines an example in which the limit value of the motor torque is drastically decreased to the minimum value at the time the travel distance reaches the durable travel distance. In this case also, the user recognizes the decrease of the travelling performance due to the limitation of the motor torque, and thereby the user can perform the maintenance.

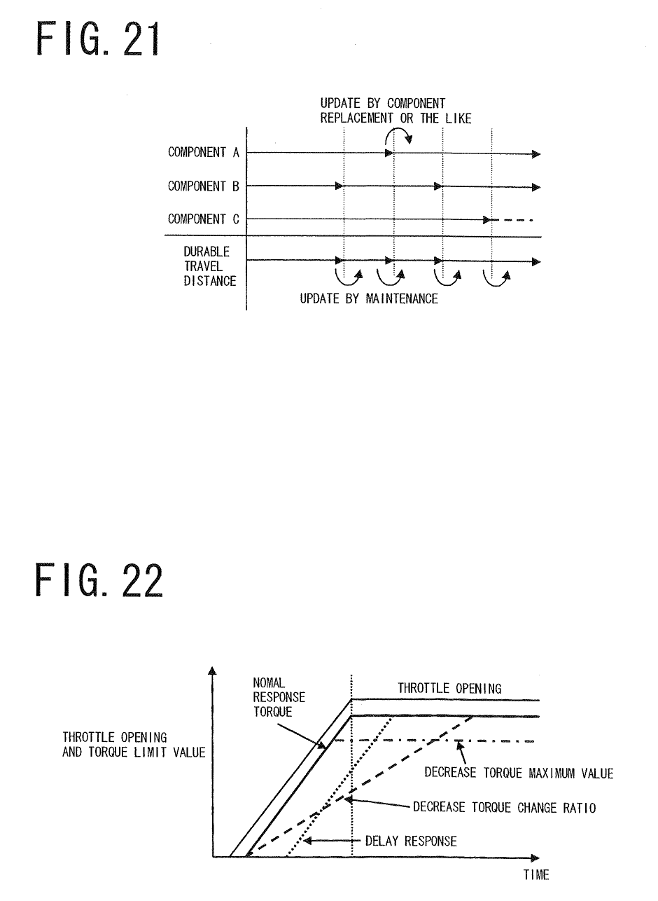

The electric vehicle of the present invention comprises a plurality of mechanical or electrical components. As shown in FIG. 21, in the case where, for example, the safety reduces in three components A, B and C especially due to the durability deterioration, the durable travel distance is set for each of these components. Every time the durable travel distance of any of these components is reached, the durable travel distance is updated by performing the maintenance. In the shown example, first, the durable travel distance of the component B is reached, and the durable travel distance of the component B is updated by performing the maintenance of the component B. However, before the updated durable travel distance is reached, the durable travel distance of the component A is reached and the durable travel distance of the component A is updated by performing the maintenance of the component A. Thereafter, after the durable travel distance of the component B is updated again, the durable travel distance of the component C is reached and the durable travel distance of the component C is updated by performing the maintenance of the component C.

Thus, by updating the duration value of each component every time the maintenance of the component is performed, the user is encouraged to perform the maintenance for each component, and thereby the maintenance of each component can be performed at an appropriate time.

The travel condition value regarding the durability which varies along with travelling is not limited to the above mentioned travel distance, but it is possible to adopt travel time, an integration value of velocity variation, an integration value of motor torque fluctuation, an integration value of environmental temperature (ambient temperature) or component temperature, or various values which vary in accordance with these values.

In the case where the travel distance is adopted as the travel condition value, for a method of determining the durable travel distance, it is possible to adopt a method of determining from a component which has the shortest life duration among the plurality of components forming the electric vehicle, a method of determining the durable travel distance for each board with the component having the shortest life duration as representative for the plurality of components mounted on one board, or the like. In the case where the travel time is adopted as the travel condition value, it is possible to determine the durable traveling time corresponding to the timing of a periodical inspection or vehicle inspection required by a law. Further, it is possible to use the durable travel distance and the durable traveling time combined with each other.

As a limitation method of the output torque when the travel distance reaches the durable travel distance, as shown in FIG. 22, it is possible to adopt a method of decreasing the maximum value of the motor torque limit value of the normal response torque in the response of the motor torque in accordance with the throttle opening, a method of decreasing a torque variation rate before the motor torque limit value reaches the maximum value, a method of delaying the response of the response torque, or a method of combining these methods.

According to the electric vehicle of the present invention described above, when the travelling condition value regarding the durability such as the travel distance or the like reaches the predetermined duration value, the subsequent motor output is limited to deteriorate the travelling performance, and therefore, the user is encouraged to perform the maintenance in a forceful manner. At this time, since the motor output is maintained at a minimum output value required for travelling, there is no problem in travelling.

The present invention is not limited to the foregoing embodiment in construction but can be modified variously within the technical scope set forth in the appended claims. For example, it is possible to adopt a structure in which the durable travel distance is variable in accordance with the usage condition of the electric vehicle.

The limitation method of the motor output is not limited to the method of limiting the motor torque as described above, but it is also possible to adopt a method of limiting the motor rotation number, the motor current, the current supplied from the battery to the motor, the voltage supplied from the battery to the motor, or the electric power supplied from the battery to the motor.

Further, it is also effective to combine the limitation of the motor output of the present invention and annunciation by warning display on an operation panel, sound of a warning buzzer or the like.

The component for which the duration value for limiting the motor output such as the travel distance, years of usage or the like may be a component to be replaced by the user such as a tire, an engine oil or the like. Also, for the setting of the duration value, it is also possible to adopt a structure in which the user himself/herself can set the duration value for the components. In particular, this can be realized by, for example, adopting a structure further including durable travel distance setting means which comprises a display part, an input key for inputting characters and numbers, and an information processing part performing information processing based on the inputted characters and numbers.

In the case where the duration value is set by the durable travel distance setting means, by inputting a component name and the duration value by using the input key, the inputted characters and numbers are processed in the information processing part, and the component name and the duration value are associated with each other and set in the durable travel distance holding part. Also, during setting, the input content is displayed in the display part.

Further, also effective is a structure in which an alarm sound or an alarm display for each component is set as an action taken at the time the travel condition value such as the travel distance or the like reaches the duration value for each component.

Still further, the present invention may be applied to not only the electric vehicle but also various electric devices such as a shaver, an electric fan, a cleaner, a laundry machine, an air conditioner, a valve opening actuator of a diesel fuel injection nozzle (a piezo injector) and the like.

For example, in the case of the shaver, the actuator is a linear motor or a piezo element, and the drive condition value is the number of use times, an accumulated usage time, a load condition (thick beard or thin beard), the accumulated number of shuttles, or any combination thereof. The object of the output limitation is a shuttle switching timing in the case where the moving speed is constant.

In the case of the electric fan, the actuator is the motor, and the drive condition value is the number of use times, an accumulated usage time, an operation mode, or any combination thereof. The object of the output limitation is the output torque, the output voltage, the output current, the mode which can be selected or the like. In the case of the cleaner, the actuator is the motor, and the drive condition value is the number of use times, the accumulated usage time, the current, the output, an operation mode, or any combination thereof. The object of the output limitation is the output torque, the output voltage, the output current, the mode which can be selected or the like.

In the case of the laundry machine, the actuator is the motor, and the drive condition value is the number of use times, the accumulated usage time, current, output, operation mode, or any combination thereof. The object of the output limitation is a mode which can be selected or the like. In the case of the air conditioner, the actuator is the motor, and the drive condition value is the number of use times, the accumulated usage time, the current, the operation mode, or any combination thereof. The object of the output limitation is a mode which can be selected or the like. In the case of the piezo injector, the actuator is a piezo element, and the drive condition value is the number of use times, the accumulated usage time, or any combination thereof. The object of the output limitation is the output torque, the output current or the like.

The electric fan is an example in which the output limitation is performed by limiting the operation mode which can be selected by the user. Here, the drive condition value is the accumulated drive time.

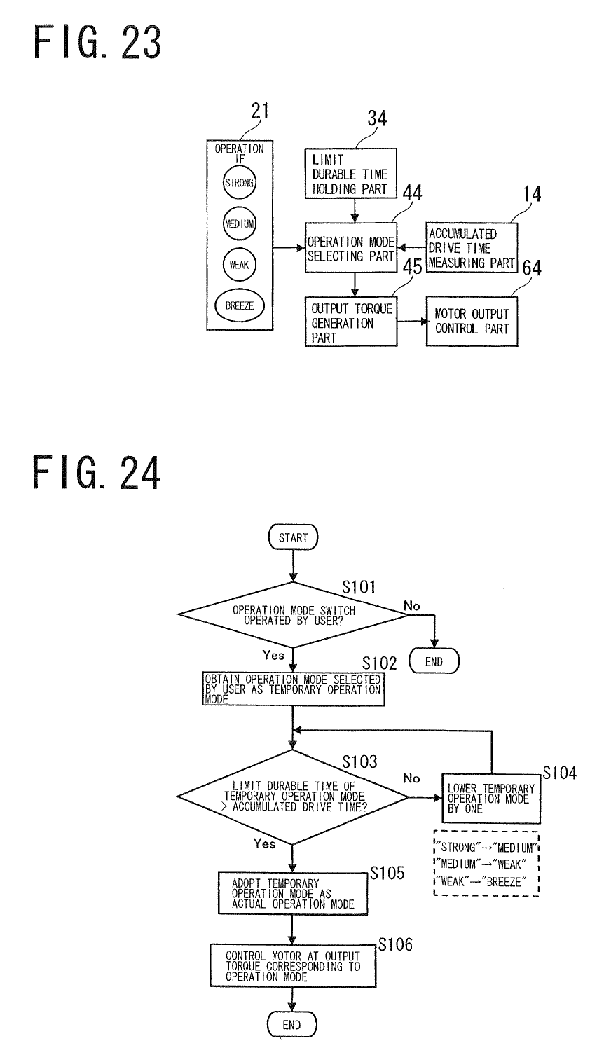

As shown in FIG. 23, the user can select four levels of the operation modes of the electric fan, which are “STRONG”, “MIDIUM”, “WEAK”, and “BREEZE” with an operation IF 21. The electric fan selects an actual operation mode of the electric fan by an operation mode selecting part 44 by using the operation mode sent from the operation IF 21, the accumulated drive time obtained from an accumulated drive time measuring part 14, and a limit durable time obtained from a limit durable time holding part 34. Here, there is a plurality of limit durable times obtained from the limit durable time holding part 34. The output torque is generated in an output torque generation part 45 in accordance with the operation mode selected in such a manner to be supplied to a motor output control part 64.

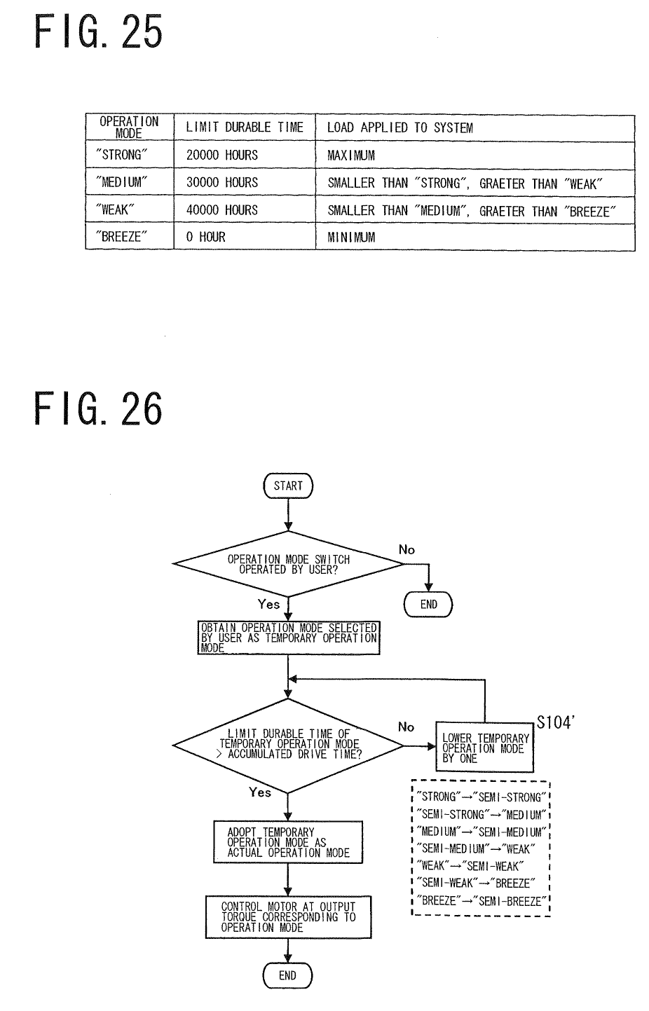

FIG. 25 shows a relation of each operation mode, the limit durable time, and the magnitude of a load applied to a system by each operation mode.

FIG. 24 shows a flow chart of the operation mode selection. In the case where the user operates the operation mode (step S101), the mode selected by the user is obtained as a temporary operation mode (step S102). Next, the limit durable time of the temporary operation mode is compared with the accumulated drive time (step S103). When the limit durable time of the temporary operation mode is greater than the accumulated drive time, the temporary operation mode is used as the actual operation mode, and the motor is controlled by a corresponding output torque (steps S105 and S106). When the limit durable time of the temporary operation mode is smaller than the accumulated drive time, the level of the temporary operation mode is lowered by one (step S104). And again, the limit durable time of the temporary operation mode is compared with the accumulated drive time. Thus, the level of the temporary operation mode is continued to be lowered until the limit durable time of the temporary operation mode becomes greater than the accumulated drive time, and thereafter, the temporary operation mode is used as the actual operation mode, and the motor is controlled by the corresponding output torque.

In particular, in the case where the accumulated drive time of the electric fan is shorter than 20,000 hours, the user can select (the electric fan can be driven at) all the four operation modes of “STRONG”, “MIDIUM”, “WEAK”, and “BREEZE”. However, after the accumulated drive time exceeds 20,000 hours, the user cannot drive the electric fan at “STRONG”. Here, this disability to drive the electric fan at “STRONG” indicates that the situation in which even when the user selects “STRONG”, the operation mode selecting part 44 transits the mode to another in a forceful manner. Further, after the accumulated drive time exceeds 30,000 hours, the user cannot drive the electric fan at “STRONG” or “MIDIUM”, and therefore, the user can select the operation mode from only two levels of “WEAK” and “BREEZE”. And then, after the accumulated drive time exceeds 40,000 hours, the user cannot drive the electric fan at “STRONG”, “MIDIUM” or “WEAK”, and therefore, the user can drive the electric fan only at “BREEZE”.

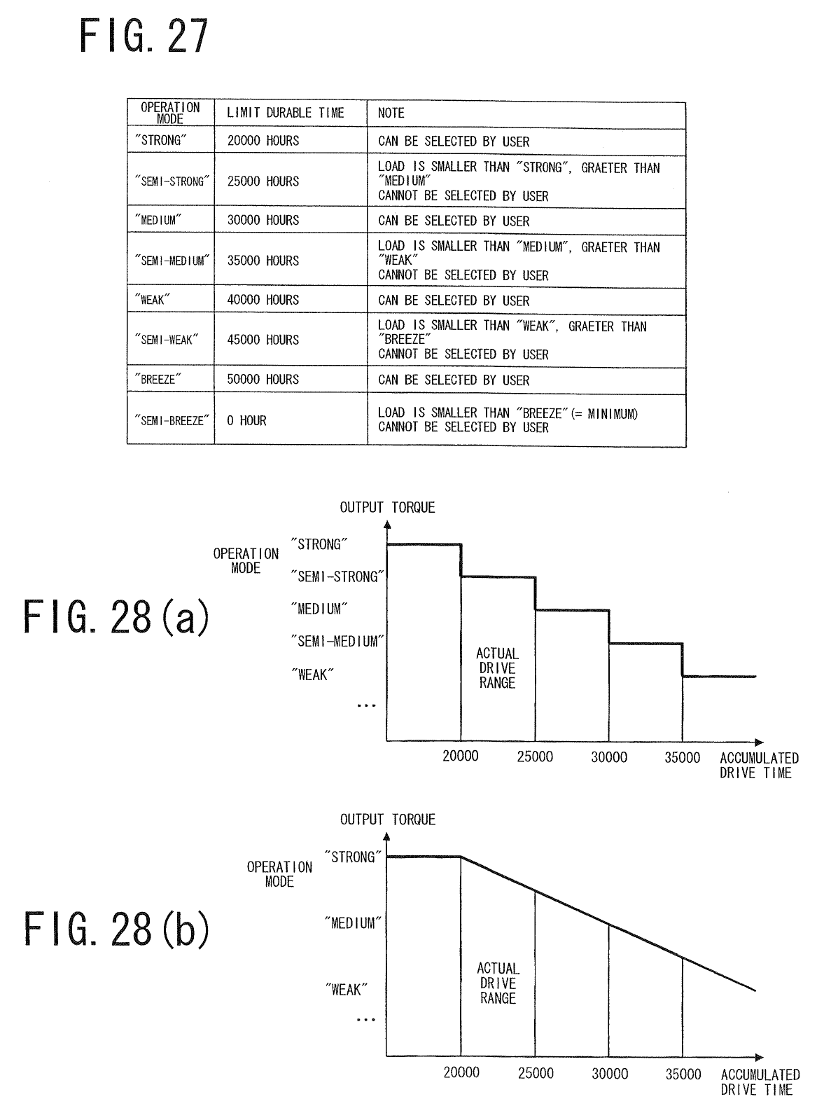

In the example described above, limited is the operation mode which can be selected by the user. However, it is also possible to apply the output limitation in a more detailed way on the electric fan side. In an example shown in FIG. 27, prepared as the operation modes are “STRONG”, “SEMI-STRONG”, “MIDIUM”, “SEMI-MIDIUM”, “WEAK”, “SEMI-WEAK”, “BREEZE”, and “SEMI-BREEZE”. FIG. 26 shows a flow chart of the operation mode selection. The difference between FIGS. 24 and 26 is the increased number of levels of the operation mode which can be lowered in the process of lowering the temporary operation mode by one (step S104′).

FIG. 27 shows the relation between each operation mode and the limit durable time in the case where the number of levels of the operation mode is increased. The load of the operation mode becomes smaller from “STRONG” to “SEMI-BREEZE” in the mentioned order. The four levels of “STRONG”, “MIDIUM”, “WEAK”, and “BREEZE” of the operation modes are the modes which can be selected by the user. In contrast, the four levels of “SEMI-STRONG”, “SEMI-MIDIUM”, “SEMI-WEAK”, and “SEMI-BREEZE” cannot be selected by the user, and are the operation modes to be selected in consideration of the accumulated drive time on the electric fan side.

For example, in the case where the accumulated drive time is shorter than 20,000 hours, the user can select all the operation modes in the four levels of “STRONG”, “MIDIUM”, “WEAK”, and “BREEZE”. When “STRONG” is selected, the operation mode remains in “STRONG”. In contrast, in the case where the accumulated drive time is 20,000 hours or longer and shorter than 25,000 hours, even when the user selects “STRONG” as the operation mode, the operation mode is automatically transited to “SEMI-STRONG” due to a condition of the accumulated drive time on the electric fan side. In the case where the accumulated drive time is 25,000 hours or longer and shorter than 30,000 hours, the operation mode is transited to “MIDIUM” or below, thereby realizing the detailed output limitation.

In the operation mode shown in FIGS. 25 and 27, a method (a first method) of reducing in stages the load to be applied to the system with the output torque in each operation mode constant as shown in FIG. 28a. However, it is also possible to adopt a method (a second method) of continuously reducing the load to be applied to the system as shown in FIG. 28b.

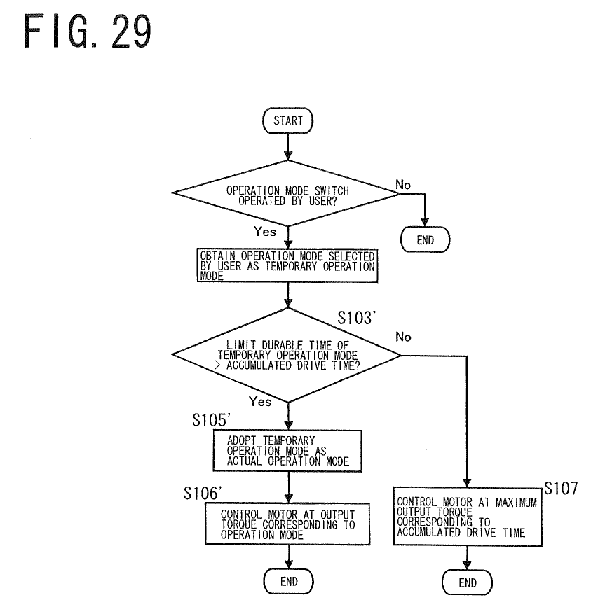

FIG. 29 shows a flow chart of the output limitation by the operation mode and a maximum output torque. When the limit durable time of the operation mode selected by the user is greater than the accumulated drive time (step S103′), the user can drive the electric fan in the selected operation mode (steps S105′ and S106′). When the limit durable time of the operation mode selected by the user is smaller than the accumulated drive time, the motor is controlled by the maximum output torque corresponding to the accumulated drive time (step S107).

That is, if the operation mode selected by the user is the operation mode within the actual drive range, the user can drive the electric fan in every operation mode. However, in the case where the operation mode outside the actual drive range is selected, in the first method, the electric fan is driven in the operation mode in which the output torque in the accumulated drive time is the maximum, while in the second method, the electric fan is driven at the maximum value of the output torque in the accumulated drive time.

1. (canceled)

2. An electric device comprising a drive part driven by an actuator and a control circuit controlling an operation of the actuator, wherein the control circuit includes detecting means for detecting a drive condition value which varies in accordance with deterioration of one or a plurality of components forming the electric device and output limit means for limiting an output of the actuator in accordance with the drive condition value detected by the detecting means, and the output limit means of the control circuit reduces a limit value of the actuator output after the drive condition value reaches a predetermined duration value from a maximum limit value to a minimum limit value.

3. The electric device according to claim 2, wherein, after the drive condition value reaches the predetermined duration value, the output limit means of the control circuit gradually reduces the limit value of the actuator output in accordance with a variation of the drive condition value from the maximum limit value to the minimum limit value.

4. The electric device according to claim 2, wherein the output limit means of the control circuit limits the actuator output by limiting an operation mode which can transit.

5. The electric device according to claim 2, wherein the actuator output is limited so that a temperature of a specified one of the components forming the electric device does not exceed a predetermined limit value, and the limit value of the component temperature decreases from a maximum limit value to a minimum limit value after the drive condition value reaches the duration value.

6. The electric device according to claim 2, wherein the electric device comprises reset means for resetting the limit value of the actuator output to the maximum limit value in accordance with conduct of maintenance.

7. The electric device according to claim 6, wherein the duration value of the drive condition value is set for each of the plurality of components forming the electric device, and the duration value of a specified component of them is updated every time the maintenance of the component is performed.

8. The electric device according to claim 2, wherein, after the drive condition value reaches the predetermined duration value, every time the actuator stops or every time a power source of the electric device is turned on, the output limit means of the control circuit reflects the limit value of the actuator output at that time in limitation of the actual actuator output.

9. The electric device according to claim 2, wherein the electric device is formed by a plurality of systems cooperating with each other, the drive condition value is data regarding a life duration of one system of the plurality of systems, the data is sent from the one system to one other system including the actuator, and the actuator output of the one other system is thereby limited.

10. An electric device comprising an electric vehicle which runs due to rotation of a motor using a battery as a power source, wherein a control circuit controlling an operation of the motor reduces a limit value of a motor output after a travel condition value regarding durability which varies along with travelling reaches a predetermined duration value from a maximum limit value to a minimum limit value.
